(19) United States
(12) Patent Application Publication
(10) Pub. No.: US 2015/0332650 A1
(43) Pub. Date: Nov. 19, 2015

(54) DISPLAY DEVICE AND DRIVE METHOD THEREOF

(71) Applicant: Sharp Kabushiki Kaisha, Osaka-shi, Osaka (JP)

(72) Inventors: Kohji SAITOH, Osaka-shi (JP); Akihisa IWAMOTO, Osaka-shi (JP); Jun NAKATA, Osaka-shi (JP); Masaki UEHATA, Osaka-shi (JP); Tomohiko NISHIMURA, Osaka-shi (JP); Ichiro UMEKAWA, Osaka-shi (JP); Masami OZAKI, Osaka-shi (JP)

(21) Appl. No.: 14/650,879

(22) PCT Filed: Dec. 6, 2013
(86) PCT No.: PCT/JP2013/082792

§ 371 Date: Jun. 10, 2015

(30) Foreign Application Priority Data
Dec. 14, 2012 (JP) 2012-274026

(51) Int. Cl. G09G 3/36; G02F 1/133; G02F 1/1368

(52) U.S. Cl. CPC G09G 3/3648; G02F 1/1368; G02F 1/13306; G09G 3/3614; G09G 2300/0876; G09G 2310/0278; G09G 2310/0289; G09G 2320/0247; G09G 2320/046

(57) ABSTRACT

Provided are a display device capable of preventing burning by suppressing occurrence of a VCOM shift which occurs when a liquid crystal panel is driven for a long period of time, and a drive method thereof. Since a source output voltage corresponding to each of tone levels from a tone value 0 to a tone value 224 agrees with a flicker regulation voltage, a shift amount from the flicker regulation voltage is set to 0 mV, and a source output voltage corresponding to a tone value 255 is obtained by further adding +40 mV as a shift amount to 4.05 V which is the flicker regulation voltage. In such a manner, a source output voltage, increased at a high tone level and in the vicinity thereof, is applied to source bus lines SL1 to SLm and written into each liquid crystal capacitance Ccl.

### TECHNICAL FIELD

The present invention relates to an active matrix-type display device, and a drive method thereof.

### BACKGROUND ART

In recent years, electronic equipment mounted with a liquid crystal display device for displaying an image and characters is under active development. As for a liquid crystal panel of the liquid crystal display device, there has often been adopted a longitudinal electric field system where two substrates and a liquid crystal layer held between these substrates are included and a pixel electrode and a common electrode are provided on the substrates, respectively. As such a longitudinal electric field system, there exist a TN (Twisted Nematic) system, a VA (Vertical Alignment) system and the like, but the longitudinal electric field system has a problem of a narrow viewing angle.

In order to solve such a problem, a lateral electric field system has been developed as a drive system for making an electric field in a direction along the substrate act on the liquid crystal layer to control an orientation of liquid crystal molecules. Generally, in a liquid crystal panel, when the same DC voltage continues to be applied to the liquid crystal layer, namely when the same image continues to be displayed, an afterimage phenomenon named “burning” occurs. It is known that this burning significantly occurs especially in a liquid crystal panel of the lateral electric field system. This is because an electrode structure provided in a pixel formation portion of the lateral electric field system is vertically asymmetrical and hence a vertical residual DC voltage is apt to be generated as compared to a pixel formation portion of the longitudinal electric field system whose electrode structure is symmetrical. As the lateral electric field system, there exist an IPS (In-Plane Switching) system, an FFS (Fringe Field Switching) system, and the like. In an electrode structure of the FFS system among these, a height from the surface of the substrate to the pixel electrode differs from a height from the same to the common electrode, and hence this electrode structure is more complex than an electrode structure of the IPS system. For this reason, in a liquid crystal panel of the FFS system, a residual DC voltage is more apt to be generated and burning is more apt to occur.

When a common voltage to be applied to the common electrode is made constant and a source output voltage (hereinafter referred to as “flicker regulation voltage”), which is regulated so as to minimize flicker at each tone level, is applied to a source bus line of the liquid crystal panel and written into the pixel formation portion, flicker of an image that is displayed on a display portion is minimized. This is because, when the flicker regulation voltage is applied, alight transmittance becomes equal between the case of a positive voltage polarity and the case of a negative voltage polarity, and hence a luminance of the image that is displayed becomes equal therebetween.

However, when such a flicker regulation voltage is applied and the liquid crystal panel of the lateral electric field system or the longitudinal electric field system is driven for a long period of time, not only flicker becomes conspicuous, but also burning comes to occur, which is problematic. As thus described, a phenomenon, in which flicker becomes conspicuous again and burning occurs when the liquid crystal panel is driven for a long period of time by applying the flicker regulation voltage, is referred to as a “VCOM shift” in the present specification.

While a detail of a mechanism in which such a VCOM shift occurs is unknown, the inventors of the present invention have an idea as follows. Since a thin film transistor (hereinafter referred to as “TFT”) provided at each pixel as a switching element has insufficient characteristics, even when absolute values of positive polarity and negative polarity voltages, taking as a reference a potential of an image signal outputted from a source driver, namely a potential of the common electrode, are made equal, transmittances of a liquid crystal layer with respect to those voltages do not become symmetrical. That is, even when the positive polarity and negative polarity voltages which have the same absolute value are applied to the pixel electrode, a luminance difference occurs in an image that is to be displayed.

FIG. 12 is a schematic view showing a state in which an orientation of liquid crystal molecules 10 changes when a voltage is applied to the liquid crystal layer held between the two substrates in the liquid crystal panel of the lateral electric field system. A reason for occurrence of flicker will be described with reference to FIG. 12. It is assumed that when no voltage is applied to the liquid crystal layer, the liquid crystal molecules 10 are oriented in a specific direction (Y-direction) within a plane parallel to the substrate. When a voltage is then applied between two electrodes so as to generate an electric field in a direction (X-direction) that goes straight with the Y-direction within the same plane, the liquid crystal molecules 10 are rotated so as to form a predetermined angle with respect to the X-direction within the plane parallel to the substrate. For example, in a case where a positive polarity voltage is applied to the liquid crystal molecules 10, the liquid crystal molecules 10 are rotated at a larger angle than that in a case where a negative polarity voltage is applied. As thus described, when the rotational angle of the liquid crystal molecules 10 is different between the case of the positive applied voltage and the case of the negative polarity voltage, a transmittance of light that is transmitted through the liquid crystal panel is different between the two cases.

Thus, when the positive polarity and negative polarity voltages are applied, absolute values of the positive polarity and negative polarity voltages are regulated such that inclinations of the liquid crystal molecules 10 become equal. That is, a common voltage is made constant, and absolute values of the positive polarity and negative polarity voltages, which are to be applied to the liquid crystal layer, in the same states are shifted to either polarity, thereby making the transmittances of the liquid crystal layer symmetrical. When the inclinations of the liquid crystal molecules 10 are made the same by performing such regulation, the light transmittances become equal and flicker becomes inconspicuous. The positive polarity and negative polarity voltages at this time are flicker regulation voltages.

Although this eliminates the difference in luminance, when the positive polarity and negative polarity voltages having unequal absolute values are alternately applied to the liquid crystal panel and it is driven for a long period of time, electric charge is accumulated into an interlayer dielectric film, a polyimide film and the like which are formed on the substrate. This accumulated electric charge leads to imbalance of the positive polarity and negative polarity voltages that are to be applied to the liquid crystal panel, and the difference therebetween further increases. This is considered to be a reason for occurrence of the VCOM shift. The accumulation of the electric charge as thus described is apt to occur in the case of displaying a high-tone image where an applied voltage is large.

Further, burning caused by the VCOM shift is considered to occur for the same reason as the above reason, and the burning is apt to occur more significantly that in the liquid crystal panel of the lateral electric field system than in the liquid crystal panel of the longitudinal electric field system, and is apt to occur especially in the liquid crystal panel of the FFS system.

Related to the present invention, Japanese Patent Application Laid-Open No. 2008-216859 discloses a configuration in a liquid crystal display device of the FFS system where burning is prevented by shifting a voltage that is given to at least one of a pixel electrode and a common electrode such that a difference in potential between the electrodes when the one electrode has a high potential as compared to the other electrode is larger than a difference in potential between the electrodes when the one electrode has a low potential.

### RELATED ART DOCUMENT

### Patent Document

Patent Document 1 [Patent Document 1] Japanese Patent Application Laid-Open No. 2008-216859

### SUMMARY OF THE INVENTION

### Problems to be Solved by the Invention

A drive method of a liquid crystal panel described in Japanese Patent Application Laid-Open No. 2008-216859 is a method for driving a liquid crystal panel by applying a flicker regulation voltage, and can suppress occurrence of flicker. However, preventing occurrence of the VCOM shift, which occurs when the flicker regulation voltage is applied and the liquid crystal panel is driven for a long period of time, is not disclosed. For this reason, with the configuration disclosed in Japanese Patent Application Laid-Open No. 2008-216859, it is not possible to prevent burning caused by the VCOM shift which occurs when the liquid crystal panel is driven for a long period of time.

Accordingly, an object of the present invention is to provide a liquid crystal display device capable of preventing burning by suppressing occurrence of a VCOM shift which occurs when a liquid crystal panel is driven for a long period of time, and a drive method thereof.

### Means for Solving the Problems

A first aspect of the present invention is directed to an active matrix-type display device which is subjected to AC drive, the device including:

a plurality of scanning signal lines and a plurality of data signal lines that intersect with the plurality of scanning signal lines;

a plurality of pixel formation portions arranged in a matrix form, respectively corresponding to intersections of the plurality of scanning signal lines and the plurality of data signal lines;

a scanning signal line drive circuit configured sequentially to activate the plurality of scanning signal lines;

a date signal line drive circuit configured to apply a flicker regulation voltage, which has been regulated so as to display an image with the minimum flicker, to the plurality of data signal lines in order to write the flicker regulation voltage into the pixel formation portion connected to a selected scanning signal line; and

a display control circuit configured to give a predetermined control signal to the scanning signal line drive circuit and the date signal line drive circuit, to perform control,

wherein one of the date signal line drive circuit and the display control circuit adds a plus shift amount to the flicker regulation voltage with a tone level in a predetermined range which at least includes the highest tone level.

According to a second aspect of the present invention, in the first aspect of the invention, the shift amount monotonously increases with increase in a tone level.

According to a third aspect of the present invention, in the second aspect of the invention, a rate of increase in shift amount with respect to the tone level rises with increase in the tone level.

According to a fourth aspect of the present invention, in the first aspect of the invention, the shift amount is a plus value at every tone level.

According to a fifth aspect of the present invention, in the first aspect of the invention, the shift amount is a plus value at a higher tone level than the predetermined tone level.

According to a sixth aspect of the present invention, in the first aspect of the invention,

the shift amount varies in accordance with a refresh frequency of an image signal given from the outside, and

the lower the refresh frequency, the larger the value of the shift amount.

According to a seventh aspect of the present invention, in the first aspect of the invention, the display control circuit stores correction data configured to correct a voltage to be written into the pixel formation portion as table information associated with a display tone corresponding to an image signal given from the outside.

According to an eighth aspect of the present invention, in the first aspect of the invention,

the pixel formation portion includes:

a thin film transistor which comes into a conducting state or a blocking state in accordance with a scanning signal that is applied to the scanning signal line;

a pixel electrode which is connected to the data signal line via the thin film transistor;

a pixel capacitance which is formed of the pixel electrode and a common electrode provided so as to face the pixel electrode; and

a liquid crystal layer which displays a pixel with a tone in accordance with a voltage that is held in the pixel capacitance,

wherein a semiconductor layer of the thin film transistor is made up of indium oxide, gallium and zinc.

According to a ninth aspect of the present invention, in the eighth aspect of the invention, the pixel formation portion includes the pixel electrode and the common electrode so as to apply an electric field in a lateral electric field system to the liquid crystal layer.

According to a tenth aspect of the present invention, in the second aspect of the invention, the pixel formation portion includes the pixel electrode and the common electrode so as to apply an electric field in a longitudinal electric field system to the liquid crystal layer.

An eleventh aspect of the present invention is directed to electronic equipment, the electronic equipment includes the display device according to the first aspect of the present invention.

A twelfth aspect of the present invention is directed to a drive method of a liquid crystal display device, the method including:

a plurality of scanning signal lines and a plurality of data signal lines that intersect with the plurality of scanning signal lines, and

a plurality of pixel formation portions arranged in a matrix form, respectively corresponding to intersections of the plurality of scanning signal lines and the plurality of data signal lines,

the device being an active matrix-type display device which is subjected to an AC drive,

the method comprising the steps of:

sequentially selecting the plurality of scanning signal lines;

applying a flicker regulation voltage, which has been regulated so as to form an image with the minimum flicker, to the plurality of data signal lines in order to write the flicker regulation voltage into the pixel formation portion connected to a selected scanning signal line; and

giving a predetermined control signal to perform control in the step of selecting the scanning signal line and the step of applying the flicker regulation voltage to the plurality of data signal lines,

wherein in the step of applying the flicker regulation voltage to the plurality of data signal lines, a plus shift amount is added to the flicker regulation voltage with a tone level in a predetermined range which at least includes the highest tone level.

### Effects of the Invention

According to the first aspect of the present invention, a voltage obtained by adding a plus shift amount to the flicker regulation voltage with a tone level in a predetermined range, which at least includes the highest tone level, is applied to the data signal line and written into the pixel formation portion. Hence the VCOM shift hardly occurs even when the display device is driven for a long period of time, thereby allowing prevention of burning.

According to the second aspect of the present invention, since the shift amount increases with increase in tone level, it is possible to increase the shift amount at the highest tone level and in the vicinity thereof. Hence it is possible to prevent burning caused by the VCOM shift, which occurs when the display device is driven for a long period of time, in accordance with the height of the tone level.

According to the third aspect of the present invention, since the rate of increase in shift amount rises with increase in tone level, it is possible to sufficiently increase the shift amount at the highest tone level and in the vicinity thereof. Hence it is possible to further prevent burning caused by the VCOM shift, which occurs when the display device is driven for a long period of time, at the highest tone level and in the vicinity thereof.

According to the fourth aspect of the present invention, since the shift amount corresponding to every tone level is a plus value, it is possible to prevent burning caused by the VCOM shift, which occurs when the display device is driven for a long period of time, at every tone level.

According to the fifth aspect of the present invention, since the shift amount corresponding to a higher tone level than the predetermined tone level is a plus value, it is possible to prevent burning caused by the VCOM shift, which occurs when the display device is driven for a long period of time, at the higher tone level than the predetermined tone level.

According to the sixth aspect of the present invention, since the most suitable shift amount can be selected with respect to each refresh frequency of an image signal, it is possible to prevent burning caused by the VCOM shift, which occurs when the display device is driven for a long period of time, regardless of the refresh frequency.

According to the seventh aspect of the present invention, it is possible to store correction data in a simple form as table information associated with a display tone corresponding to an image signal.

According to the eighth aspect of the present invention, characteristics of the thin film transistor, whose semiconductor layer is made up of indium oxide, gallium and zinc, are improved. Therefore, when absolute values of the positive polarity and negative polarity voltages, which are held in the pixel capacitance, are made equal, transmittances of the liquid crystal layer can be made symmetrical. Hence it is possible to prevent burning caused by the VCOM shift which occurs when the display device is driven for a long period of time.

According to the ninth aspect of the present invention, in the display device of the lateral electric field system, it is possible to prevent burning caused by the VCOM shift which occurs when the display device is driven for a long period of time.

According to the tenth aspect of the present invention, in the display device of the longitudinal electric field system, it is possible to prevent burning caused by the VCOM shift which occurs when the display device is driven for a long period of time.

According to the eleventh aspect of the present invention, a similar effect to that of the first aspect of the present invention can be exerted in the electronic equipment.

According to the twelfth aspect of the present invention, a similar effect to that of the first aspect of the present invention can be exerted in the drive method of the display device.

### BRIEF DESCRIPTION OF THE DRAWINGS

FIG. 1 is a block diagram showing a configuration of a liquid crystal display device according to a first embodiment of the present invention;

FIG. 2 is a circuit diagram showing an equivalent circuit of a pixel formation portion included in a display portion of the liquid crystal display device shown in FIG. 1;

FIG. 3 is a block diagram showing a configuration of a source driver included in the liquid crystal display device shown in FIG. 1;

FIG. 4 is a circuit diagram showing a configuration of a voltage division circuit of a tone voltage generation circuit included in the liquid crystal display device shown in FIG. 1;

FIG. 5 is a diagram showing the relation between an average value of source output voltages and a tone level in a liquid crystal panel of an FFS system included in the liquid crystal display device shown in FIG. 1;

FIG. 6 is a diagram representing the source output voltage shown in FIG. 5 by means of a shift amount from a flicker regulation voltage;

FIG. 7 is a diagram showing the relation between the shift amount from the flicker regulation voltage and the tone level in a liquid crystal panel of the FFS system included in a liquid crystal display device according to a second embodiment;

FIG. 8 is a diagram showing the relation between the shift amount from the flicker regulation voltage and the tone level in a liquid crystal panel of the FFS system included in a liquid crystal display device according to a third embodiment;

FIG. 9 is a diagram showing the relation between the shift amount from the flicker regulation voltage and the tone level with respect to each refresh frequency in a liquid crystal panel of the FFS system included in a liquid crystal display device according to a fourth embodiment;

FIG. 10 is a block diagram showing a configuration of a display control circuit included in a liquid crystal display device according to a fifth embodiment;

FIG. 11 is a diagram showing, as LUT, the relation between the source output voltage and the tone level in the case of a refresh frequency of 30 Hz and the case of a refresh frequency of 60 Hz in a liquid crystal panel shown in FIG. 10; and

FIG. 12 is a schematic view showing a state in which an orientation of liquid crystal molecules changes when a voltage is applied to a liquid crystal layer held between two substrates in a liquid crystal panel of a lateral electric field system.

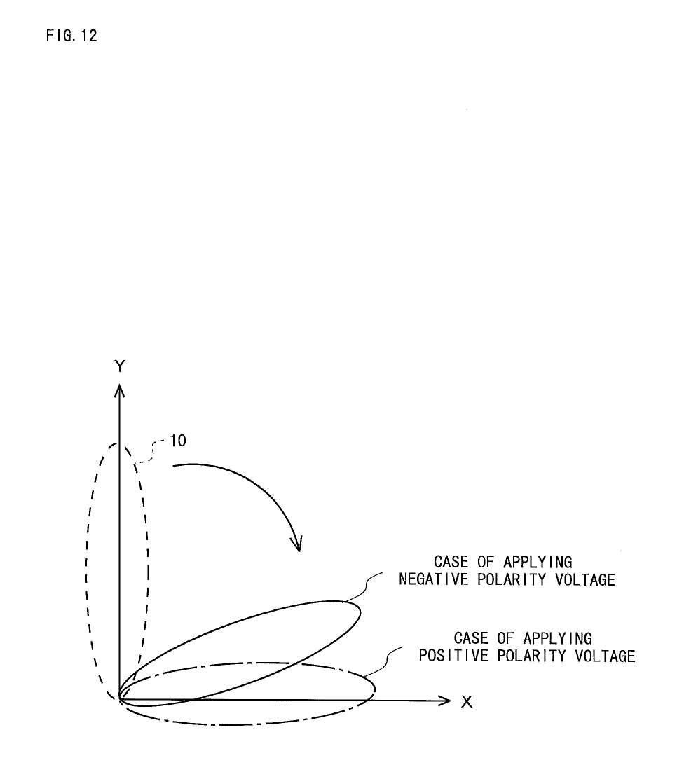

### MODE FOR CARRYING OUT THE INVENTION

### 1. First Embodiment

<1.1 Whole Configuration of Liquid Crystal Display Device>

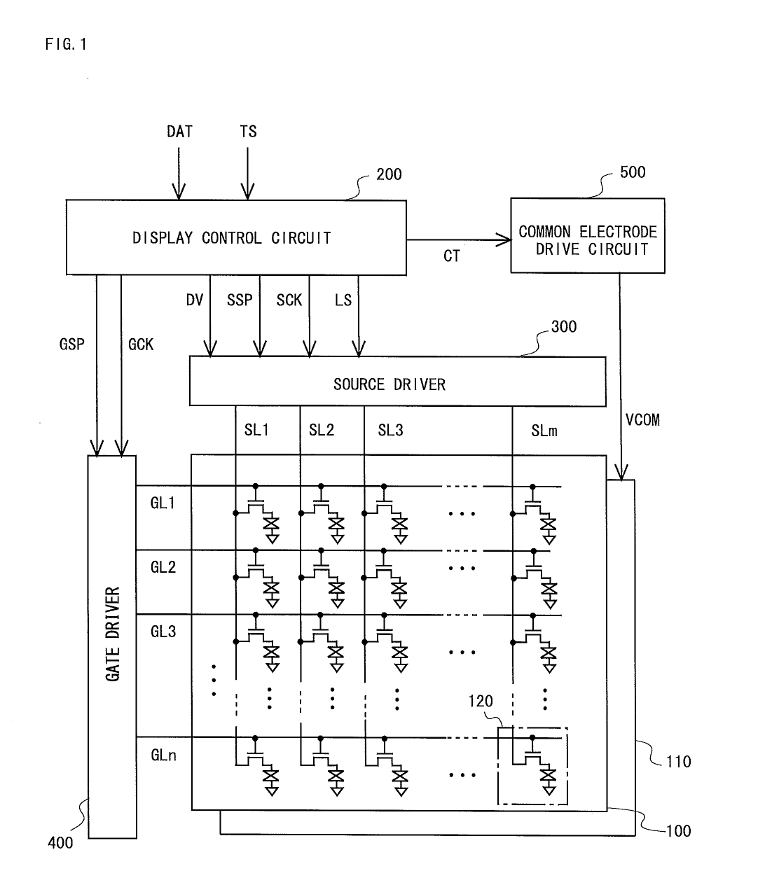

FIG. 1 is a block diagram showing a configuration of a liquid crystal display device according to a first embodiment of the present invention. As shown in FIG. 1, this liquid crystal display device is provided with: a liquid crystal panel including a display portion 100 arranged with a plurality of pixel formation portions 120 in a matrix form; a display control circuit 200 formed at a picture-frame of the display portion 100; a source driver (video signal line drive circuit) 300; a gate driver (scanning signal line drive circuit) 400; and a common electrode drive circuit 500, the device being capable of displaying an image with 256 tones. This liquid crystal display device is mounted in any electronic equipment having a display portion, such as a smart phone, a computer and a digital camera. It is to be noted that a description will be given in the present specification assuming that the liquid crystal panel is a panel of the lateral electric field system; however, the liquid crystal panel may be a panel of the longitudinal electric field system.

In the display portion 100, a plurality of (m) source bus lines (date signal line drive circuit) SL1 to SLm and a plurality of (n) gate bus lines (scanning signal lines) GL1 to GLn are arranged so as to intersect with each other, and a pixel formation portion 120 is provided in the vicinity of each of intersections of the source bus lines SL1 to SLm and the gate bus lines GL1 to GLn.

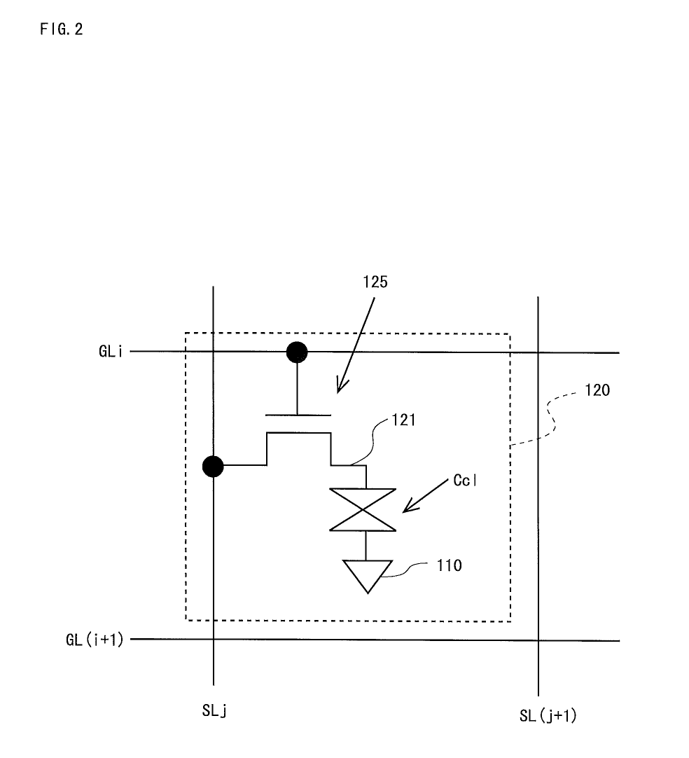

FIG. 2 is a circuit diagram showing an equivalent circuit of the pixel formation portion 120 included in the display portion 100 of the liquid crystal display device shown in FIG. 1. Each pixel formation portion 120 is provided with: a TFT 125 whose gate electrode is connected to a gate bus line GLi (1≦i≦n) passing through a corresponding intersection and whose source electrode is connected to a source bus line SLj (1≦j≦m) passing through this intersection, and which functions as a switching element; a pixel electrode 121 connected to a drain electrode of the TFT 125; a common electrode 110 which faces the pixel electrode 121 and is commonly provided in each pixel formation portion 120; and a liquid crystal capacitance Ccl made up of a liquid crystal layer (not shown) held between the pixel electrode 121 and the common electrode 110. In addition, although an auxiliary capacitance is also formed in parallel to the liquid crystal capacitance Ccl, the auxiliary capacitance is not directly related to the present invention, and hence an illustration and a description of the auxiliary capacitance will be omitted in the present specification. It is thus assumed in the present specification that the pixel capacitance is made up of the liquid crystal capacitance Ccl alone.

As the TFT 125 that functions as the switching element of the pixel formation portion 120, for example, a TFT whose semiconductor layer is an oxide semiconductor (hereinafter referred to as “oxide TFT”) is used. More specifically, the semiconductor layer of the TFT 125 is formed of In—Ga—Zn—O (indium-gallium-zinc-oxide) mainly composed of indium (In), gallium (Ga), zinc (Zn) and oxygen (O). Hereinafter, a TFT using In—Ga—Zn—O for the semiconductor layer will be referred to as an “IGZO-TFT”. The IGZO-TFT has a very small off-leak current as compared to a silicon-based TFT using polycrystalline silicon, amorphous silicon or the like for a semiconductor layer. For this reason, a driving signal voltage (source output voltage) written into the liquid crystal capacitance Ccl is held for a long period. Further, characteristics of the TFT 125 whose semiconductor layer is made up of In—Ga—Zn—O can be improved as compared to those of the silicon-based TFT. Therefore, absolute values of the positive polarity and negative polarity flicker regulation voltages, which are held in the liquid crystal capacitance Ccl, are made equal, whereby transmittances of the liquid crystal layer can be made symmetrical. Hence it is possible to prevent burning caused by the VCOM shift which occurs when the liquid crystal display device is driven for a long period of time.

It should be noted that a similar effect is also obtained in a case where, for example, an oxide semiconductor containing at least one of indium, gallium, zinc, copper (Cu), silicon (Si), tin (Sn), aluminum (Al), calcium (Ca), germanium (Ge) and lead (Pb) is used for the semiconductor layer as an oxide semiconductor other than In—Ga—Zn—O. Further, using the oxide TFT as the TFT 111 is one example, and in place of this, the silicon-based TFT of polycrystalline silicon, amorphous silicon or the like may be used.

The display control circuit 200 receives image data DAT (image signal) transmitted from the outside such as a system control portion of electronic equipment mounted with the liquid crystal display device and a timing control signal TS such as a vertical synchronization signal and a horizontal synchronization signal, outputs a digital image signal DV, a source start pulse signal SSP, a source clock signal SCK and a latch strobe signal LS to the source driver 300, outputs a gate start pulse signal GSP and a gate clock signal GCK to the gate driver 400, and outputs a common voltage control signal CS, which controls a common voltage VCOM to be applied to the common electrode 110, to the common electrode drive circuit 500.

The source driver 300 receives the digital image signal DV, the source start pulse signal SSP, the source clock signal SCK and the latch strobe signal LS outputted from the display control circuit 200, and applies a source output voltage, generated based on the digital image signal DV, to each of the source bus lines SL1 to SLm in order to charge the liquid crystal capacitance Ccl of each pixel formation portion 120. A detailed configuration of the source driver 300 will be described later.

The gate driver 400 sequentially applies an active scanning signal to each of the gate bus lines GL1 to GLn based on the gate start pulse signal GSP and the gate clock signal GCK outputted from the display control circuit 200 in order to sequentially select each of the gate bus lines GL1 to GLn in each horizontal period.

The common electrode drive circuit 500 gives a voltage given from a power supply circuit (not shown) as the common voltage VCOM to the common electrode 110, and reverses the polarity of the common voltage VCOM at timing in accordance with an AC drive system such as line reversal or frame reversal based on the common voltage control signal CS given from the display control circuit 200.

<1.2 Source Driver>

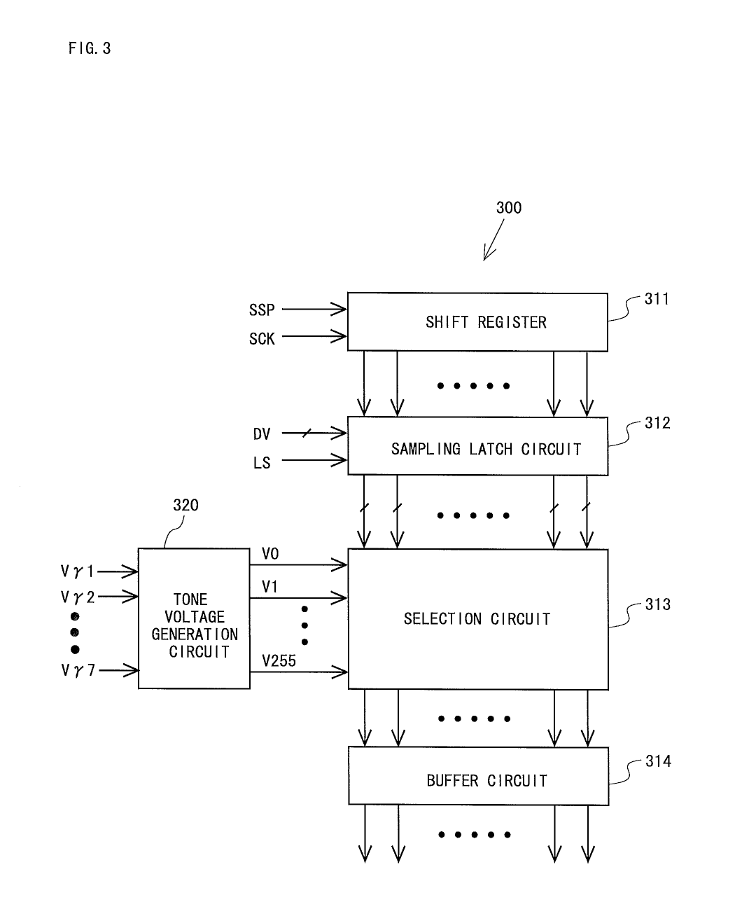

FIG. 3 is a block diagram showing a configuration of the source driver 300 included in the liquid crystal display device shown in FIG. 1. This source driver 300 is provided with a shift register 311, a sampling latch circuit 312, a selection circuit 313, a buffer circuit 314, and a tone voltage generation circuit 320.

The shift register 311 is inputted with the source start pulse signal SSP and the source clock signal SCK outputted from the display control circuit 200. Based on these signals SSP, SCK, the shift register 311 transmits each pulse included in the source start pulse signal SSP from an input end to an output end. In accordance with this transfer, sampling pulses are sequentially inputted into the sampling latch circuit 312. The sampling latch circuit 312 samples the digital image signal DV outputted from the display control circuit 200 at timing of each of these sampling pulse to hold the sampled signals, and further outputs together those signals as 8-bit internal image signals d1, d2, . . . dm at timing when the latch strobe signal LS is inputted.

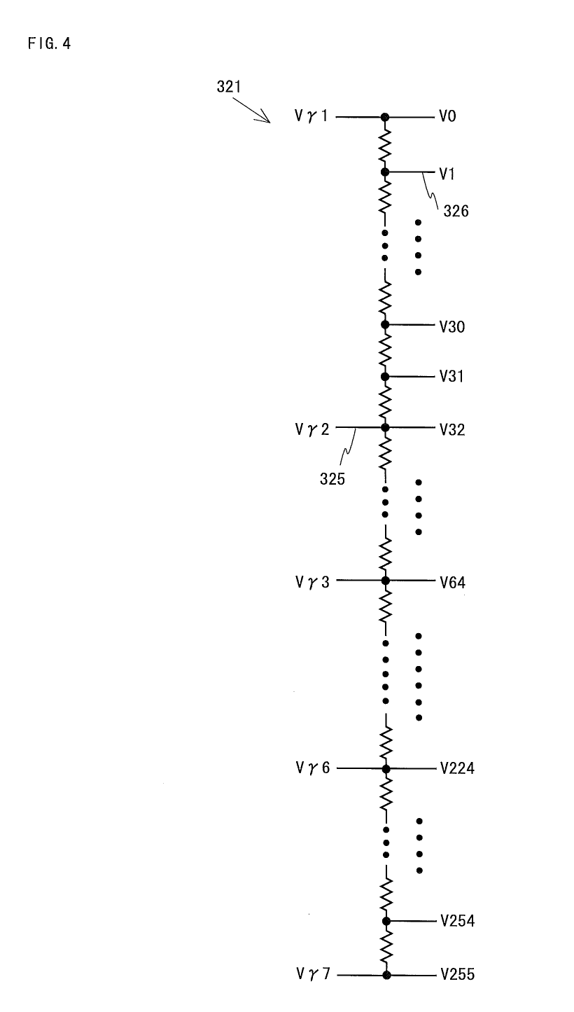

The power supply circuit gives, to the tone voltage generation circuit 320, seven kinds of voltages (hereinafter referred to as “tone reference voltages”) Vγ1 to Vγ7 that become references for generating a group of tone voltages V0 to V255. As shown in FIG. 4, the tone voltage generation circuit 320 is provided with a voltage division circuit 321 made up of a resistor row formed by connecting 255 resistors in series. The voltage division circuit 321 divides the tone reference voltages Vγ1 to Vγ7 by the resistors, to generate the group of tone voltages V0 to V255. Specifically, the seven tone reference voltages Vγ1 to Vγ7 are respectively given to seven input terminals 325. A plurality of resistors, connected in series to each other, are connected between input terminals 325. For example, an output terminal 326, provided at a connection portion of each of 32 resistors provided between the input terminal 325 to which the tone reference voltage Vγ0 has been given and the input terminal 325 to which the tone reference voltage Vγ2 has been given, outputs a group of 33 tone voltages V0 to V32 having different voltage values. With the respective tone reference voltages Vγ3 to Vγ7 being also given to the other input terminals 325, the voltage division circuit 321 generates the group of tone voltages V0 to V255 with 256 tones, and gives those to the selection circuit 313. In addition, it is assumed in the present specification that the tone reference voltages Vγ1 to Vγ7 are voltages respectively corresponding to tone levels of a tone value 0, the tone value 32, a tone value 64, a tone value 128, a tone value 192, a tone value 224 and a tone value 255. However, the number of kinds of tone reference voltages may be larger or smaller than seven, or the tone reference voltage may be made to correspond to a different tone level from the above tone level.

In the tone voltage generation circuit 320 as thus described, in the case of increasing voltage values of some tone voltages out of the group of tone voltages V0 to V255, a resistance value of the resistor connected to the output terminal 326 for outputting the voltage value is increased. When the seven kinds of tone reference voltages Vγ1 to Vγ7 are inputted to the respective input terminals 325 of the voltage division circuit 321 as thus described, the voltage division circuit 321 can output the flicker regulation voltage or a voltage obtained by shifting the flicker regulation voltage to the plus side by a desired shift amount.

The selection circuit 313 selects any voltage out of the group of tone voltages V0 to V255, generated as described above, based on the internal image signals d1, d2, . . . dm outputted from the sampling latch circuit 312. The buffer circuit 314 receives the source output voltage outputted from the selection circuit 313, and for example, performs impedance conversion by means of a voltage follower, to output the converted voltage as a driving signal voltage. The source output voltage outputted from the buffer circuit 314 is applied to the source bus lines SL1 to SLm.

In such a manner, the active scanning signal is applied to the gate bus lines GL1 to GLn, the source output voltage is applied to the source bus lines SL1 to SLm, and the common voltage VCOM is applied to the common electrode 110. Accordingly, the liquid crystal capacitance Ccl of each pixel formation portion 120 is charged with the source output voltage, the transmittance of the liquid crystal layer changes in accordance with the image data DAT, and an image is displayed on the display portion 100.

<1.3 Regulation of Source Output Voltage>

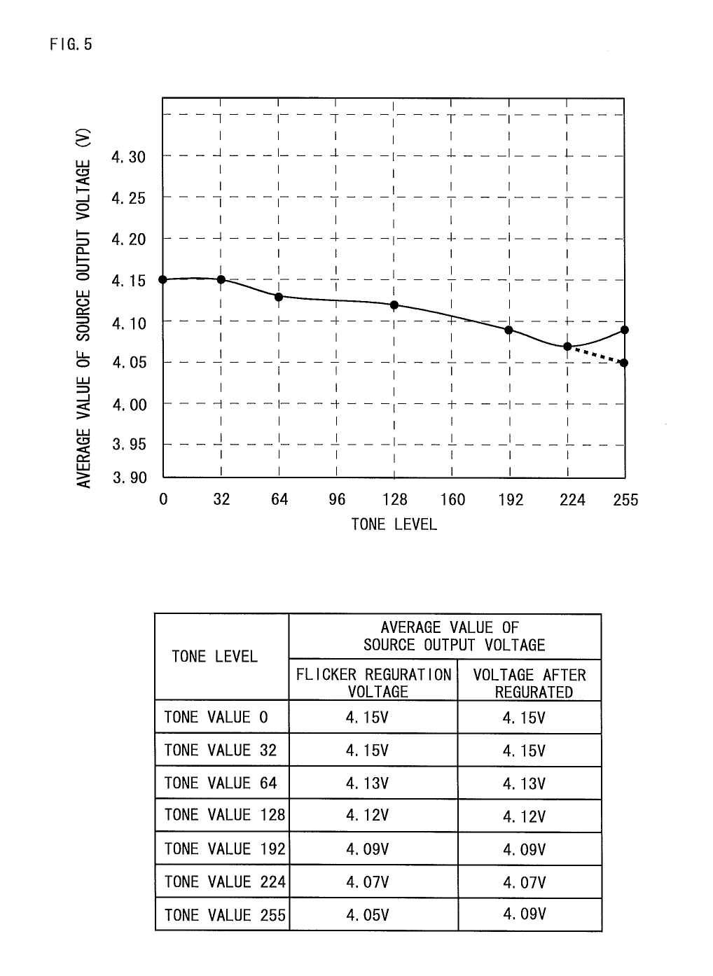

FIG. 5 is a diagram showing the relation between an average value of source output voltages and the tone level in the liquid crystal panel of the FFS system of the present embodiment. Here, in the present specification, the source output voltage means the flicker regulation voltage or a voltage obtained by further shifting the flicker regulation voltage to the plus side by a predetermined value, namely a voltage obtained by adding a plus shift amount to the flicker regulation voltage. Since the source output voltage is thus a voltage to be applied to the source bus lines SL1 to SLm and the same as the above driving signal voltage, the “source output voltage” may be referred to in place of the “driving signal voltage” in the following description. Further, the average value of the source output voltages refers to an average value of positive polarity and negative polarity source output voltages.

As shown in FIG. 5, at the tone value 255 and in the vicinity thereof, the voltage obtained by further shifting the flicker regulation voltage to the plus side by a predetermined value is taken as the source output voltage, and at the tone levels other than this, the flicker regulation voltage is taken as the source output voltage. Specifically, it is assumed that the tone reference voltages corresponding to the tone levels of the tone value 0, the tone value 32, the tone value 64, the tone value 128, the tone value 192 and the tone value 224 are equal to the flicker regulation voltages, and the tone reference voltage corresponding to the tone value 255 is 4.09 V obtained by further adding +40 mV as a shift amount to 4.05 V which is the flicker regulation voltage. Accordingly, when seven kinds of source output voltages shown in FIG. 5 are inputted as the tone reference voltages Vγ1 to Vγ7 into the tone voltage generation circuit 320, the tone voltage generation circuit 320 outputs the group of tone voltages V0 to V255, and the group of these tone voltages V0 to V255 is selected by the selection circuit 313 and applied as the source output voltage to the source bus lines SL1 to SLm. Thereby, the source output voltage is written into the pixel formation portion 120 connected to the selected gate bus line.

The source output voltage corresponding to each of tone levels from the tone value 0 to the tone value 224 as thus obtained has the same voltage value as that of the flicker regulation voltage, and the source output voltage corresponding to each of tone levels from the tone value 225 to a tone value 254 is a voltage (solid line shown in FIG. 5) obtained by further shifting the flicker regulation voltage (dotted line shown in FIG. 5) to the plus side.

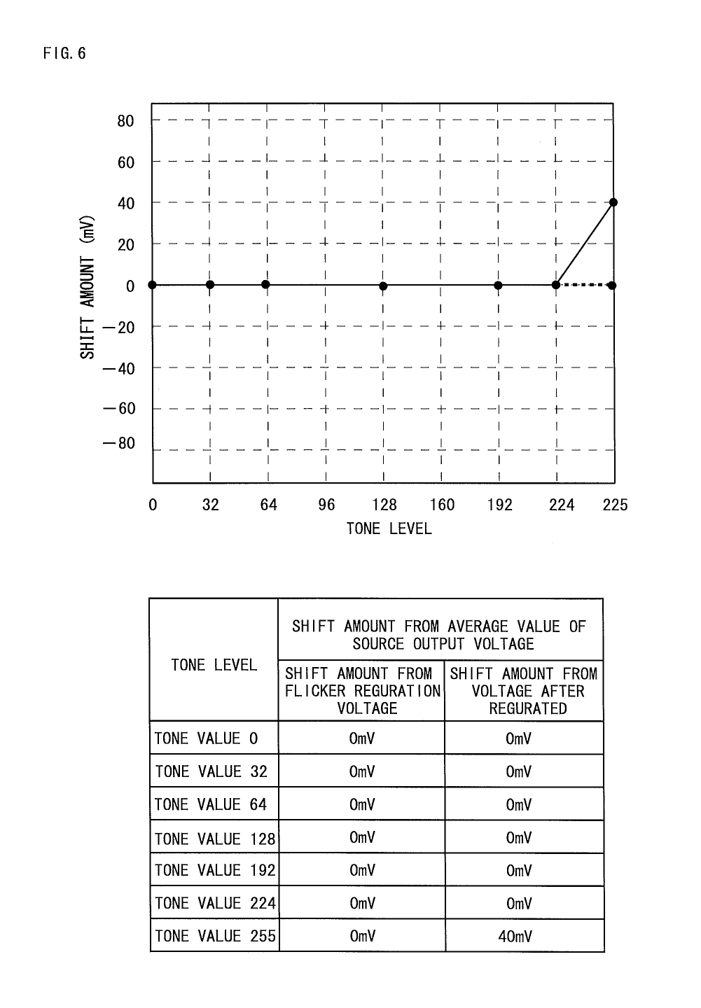

FIG. 6 is a diagram representing the source output voltage shown in FIG. 5 by means of a shift amount from the flicker regulation voltage. As described above, the source output voltage corresponding to each of tone levels from the tone value 0 to the tone value 224 agrees with the flicker regulation voltage, and hence the shift amount is 0 mV. In contrast, the source output voltage corresponding to the tone value 255 is obtained by further adding +40 mV to 4.05 V which is the flicker regulation voltage, and hence the shift amount is +40 mV. Moreover, the shift amount from the tone value 225 to the tone value 254 is a difference between a voltage value represented by a solid line of FIG. 6 and a voltage value represented by a dotted line of FIG. 6. That is, the shift amount at each of tone levels from the tone value 225 to the tone value 254 is represented by a straight line connecting 0 mV at the tone value 224 and +40 mV at the tone value 255 in FIG. 6. Therefore, the shift amount of the source output voltage increases with increase in tone level.

In addition, in the present embodiment that the shift regulation voltage shifted from the flicker regulation voltage at the tone value 255 by +40 mV has been taken as the source output voltage corresponding to the tone value 255. However, the shift amount is not restricted to +40 mV, and can be changed as appropriate so long as it is a plus value.

<1.4 Effect>

According to the present embodiment, as the source output voltage corresponding to each of the tone value 255 as the highest tone level and tone levels in the vicinity thereof, the flicker regulation voltage obtained by shifting the flicker regulation voltage with the positive polarity and the negative polarity to the plus side is applied, and as the source output voltage corresponding to each of the other tone levels, the flicker regulation voltage is applied, to drive the liquid crystal panel. When such a source output voltage is applied to the liquid crystal panel and the liquid crystal panel is driven for a long period of time, occurrence of the VCOM shift is suppressed, thereby allowing prevention of burning caused by the VCOM shift. This is because it can be considered that, by increasing the flicker regulation voltage corresponding to the highest tone level and in the vicinity thereof, electric charge is hardly accumulated in the liquid crystal panel even when the liquid crystal panel is driven for a long period of time.

<1.5 Modified Example>

The liquid crystal panel may be driven for a long period of time by using as the source output voltage a voltage obtained not only by shifting the flicker regulation voltage corresponding to each of the tone value 255 as the highest tone level and tone levels in the vicinity thereof to the plus side, but also by shifting the flicker regulation voltage corresponding to each of tone levels from a tone value 193 to the tone value 255 to the plus side, or by shifting the flicker regulation voltage corresponding to each of tone levels from the tone value 128 to the tone value 255 to the plus side. As thus described, a voltage, obtained by shifting the flicker regulation voltage corresponding to the tone level at least including the tone value 255 as the highest tone level to the plus side, is taken as the source output voltage, whereby it is possible to further suppress occurrence of the VCOM shift, so as to further prevent burning caused by the VCOM shift. In this case, it is preferable to set the shift amount so as to monotonously increase with increase in tone level and to become the largest at the tone value 255.

<2. Second Embodiment>

A block diagram showing a configuration of a liquid crystal display device according to a second embodiment is similar to the block diagram shown in FIG. 1, and hence the block diagram and a description thereof will be omitted.

<2.1 Regulation of Source Output Voltage>

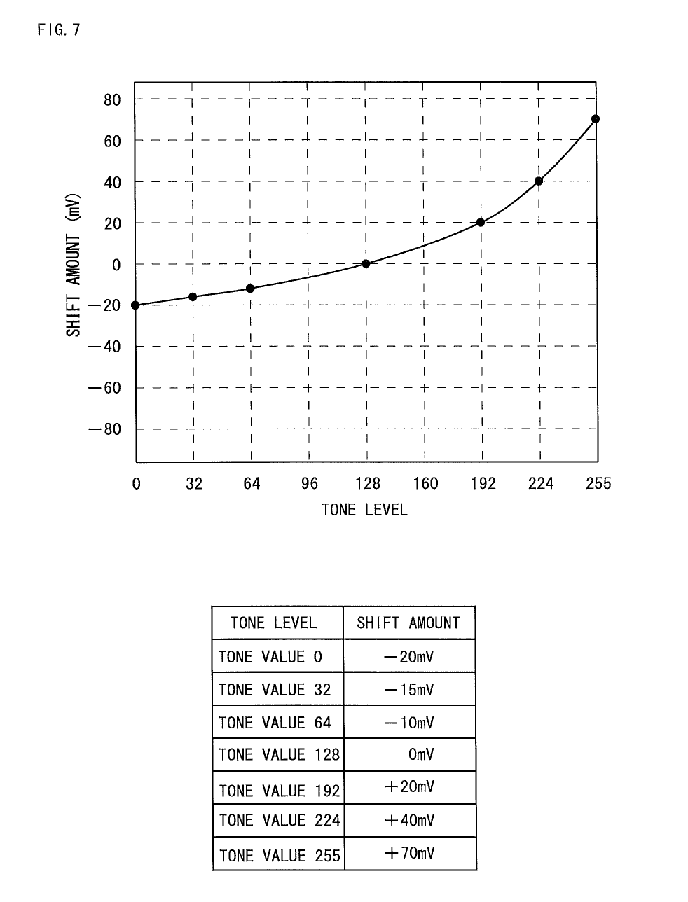

FIG. 7 is a diagram showing the relation between the shift amount from the flicker regulation voltage and the tone level in a liquid crystal panel of the FFS system of the present embodiment. As shown in FIG. 7, the shift amounts from the flicker regulation voltages as the source output voltages in the present embodiment are set to 0 mV at the tone value 128, and set to −20 mV, −15 mV and −10 mV respectively at the tone value 0, the tone value 32 and the tone value 64 which are smaller tone levels than the tone value 128. Further, it is assumed that shift amounts are set to +20 mV, +40 mV and +70 mV respectively at the tone value 192, the tone value 224 and the tone value 255 which are larger tone levels than the tone value 128. As thus described, with increase in tone level, not only the shift amount monotonously increases, but also a rate of increase (inclination of curve) in shift amount is raised. As a result, the shift amount corresponding to the tone value 0 level is the smallest amount of −20 mV, and the shift amount corresponding to the tone value 255 is the largest amount of +70 mV.

In such a manner, the source output voltage is obtained by adding the shift amount to the flicker regulation voltage at every tone from the tone value 0 to the tone value 255. In addition, differently from the case of the first embodiment, the shift amounts include zero and a minus value as well as a plus value in the present embodiment. Therefore, adding a minus shift amount to the flicker regulation voltage means shifting the flicker regulation voltage to the minus side.

Accordingly, when seven kinds of source output voltages obtained by adding the shift amounts shown in FIG. 7 are inputted as the tone reference voltages Vγ1 to Vγ7 to the tone voltage generation circuit 320, the tone voltage generation circuit 320 outputs the group of tone voltages V0 to V255, and the group of these tone voltages V0 to V255 is selected by the selection circuit 313 and applied as the source output voltage to the source bus lines SL1 to SLm. Thereby, the source output voltage is written into each pixel formation portion 120.

<2.2 Effect>

According to the present embodiment, the source output voltage from the tone value 0 to a tone value 127 is set to the voltage obtained by shifting the flicker regulation voltage to the minus side, and the source output voltage from a tone value 129 to the tone value 255 is set to the voltage obtained by shifting the flicker regulation voltage to the plus side, and hence such voltages are set so that the rate of increase in shift amount rises with increase in tone level. Since the source output voltage corresponding to the highest tone level and in the vicinity thereof thus increases, even when the source output voltage is applied to the liquid crystal panel and the liquid crystal panel is driven for a long period of time, occurrence of the VCOM shift is suppressed. This leads to prevention of burning caused by the VCOM shift.

<2.3 Modified Example>

In the present embodiment, the shift amount from the flicker regulation voltage corresponding to the tone value 128 has been set to 0 mV, the shift amount at a smaller tone level than the tone value 128 has been set to a minus value, and the shift amount at a larger tone level than the tone value 128 has been set to a plus value. However, the tone level at which the shift amount is 0 mV is not restricted to the tone value 128, and the tone level may be any tone level except for the highest tone level and in the vicinity thereof.

### 3. Third Embodiment

A block diagram showing a configuration of a liquid crystal display device according to a third embodiment is the same as the block diagram shown in FIG. 1, and hence the block diagram and a description thereof will be omitted.

<3.1 Regulation of Source Output Voltage>

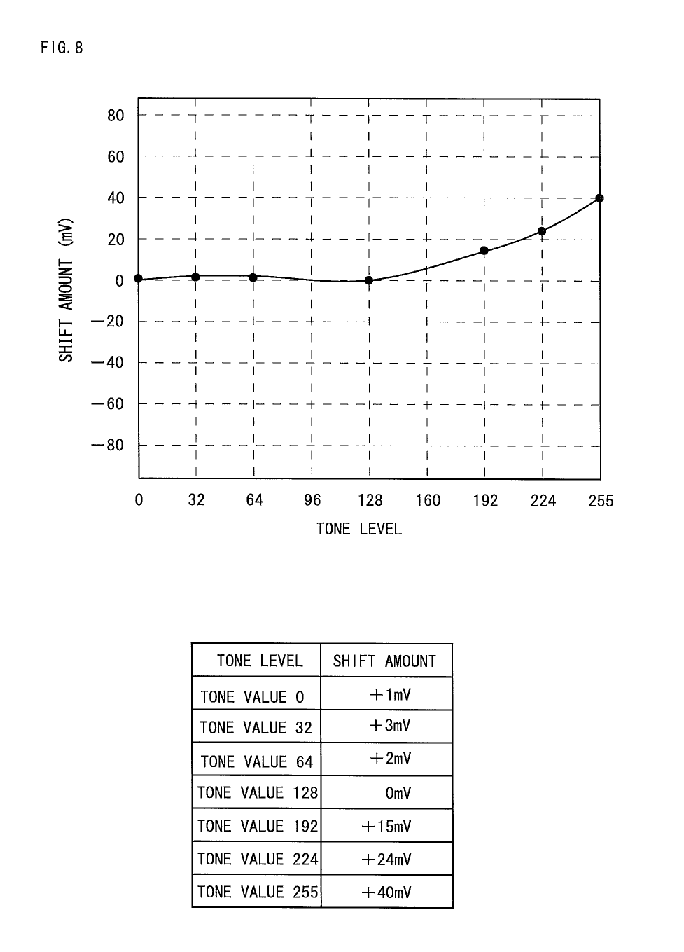

FIG. 8 is a diagram showing the relation between the shift amount from the flicker regulation voltage and the tone level in a liquid crystal panel of the FFS system of the present embodiment. As shown in FIG. 8, as for the shift amount in the present embodiment, a shift amount from the flicker regulation voltage corresponding to the tone value 128 is set to 0 mV, shift amounts at the tone value 0, the tone value 32 and the tone value 64 that are smaller tone levels than the tone value 128 are set to small plus values as well as substantially the same value (+1 to +3 mV in the drawing), and shift amounts at the tone value 192, the tone value 224 and the tone value 255 that are larger tone levels than the tone value 128 are respectively set to +15 mV, +24 mV and +40 mV. As thus described, when the tone level is smaller than the tone value 128, the shift amount is set to a small plus value as well as substantially the same value, and when the tone level is larger than the tone value 128, the shift amount is monotonously increased with increase in tone level, and a rate of increase (inclination of curve) in shift amount is also raised. Hence the shift amount at the tone value 255 is the largest amount of 40 mV. In addition, differently from the case of the second embodiment, the shift amounts do not include a minus value.

Accordingly, when seven kinds of source output voltages obtained by adding the shift amounts shown in FIG. 8 are inputted as the tone reference voltages Vγ1 to Vγ7 to the tone voltage generation circuit 320, the tone voltage generation circuit 320 outputs the group of tone voltages V0 to V255, and the group of these tone voltages V0 to V255 are selected by the selection circuit 313 and applied as the source output voltage to the source bus lines SL1 to SLm. Thereby, the source output voltage is written into each pixel formation portion 120.

<3.2 Effect>

According to the present embodiment, the source output voltage is set so that the flicker regulation voltage is shifted to the plus side at every tone level, and the rate of increase in shift amount rises with increase in tone level at a larger tone level than the tone value 128. Since the source output voltage corresponding to the highest tone level and in the vicinity thereof thus increases, even when the source output voltage is applied to the liquid crystal panel and the liquid crystal panel is driven for a long period of time, occurrence of the VCOM shift is suppressed. This leads to prevention of burning caused by the VCOM shift.

<3.3 Modified Example>

In the present embodiment, the shift amount at the tone value 128 has been set to 0 mV, and the shift amount corresponding to each of tone levels from the tone value 0 to the tone value 127 has been set to a plus small value as well as the substantially fixed value. However, the tone level at which the shift amount is 0 mV is not restricted to the tone value 128, and the tone level may be any tone level except for the highest tone level and in the vicinity thereof.

### 4. Fourth Embodiment

<4.1 Configuration of Liquid Crystal Display Device>

In a block diagram showing a configuration of a liquid crystal display device according to a fourth embodiment, refresh frequency information of an image that is further displayed is given to the display control circuit 200 from the outside along with the image data DAT and the timing control signal TS such as the horizontal synchronization signal in the block diagram shown in FIG. 1. In order to switch an image that is displayed on the display portion 100 in accordance with information of a refresh frequency of 30 Hz or 60 Hz, the display control circuit 200 is provided with a switch circuit (not shown) for switching the control signals such as the source start pulse signal SSP and the source clock signal SCK to be given to the source driver 300, and the control signals such as the gate clock signal GCK to be given to the gate driver 400.

Further, the tone voltage generation circuit 320 includes two voltage division circuits (not shown) that can be switched in accordance with the refresh frequency. These voltage division circuits are both made up of resistors connected in series, but resistance values of the resistors constituting the two voltage division circuits are different. The two voltage division circuits are switched by a switch signal (not shown) given from the switch circuit of the display control circuit 200. The other constitutional elements are the same as the constitutional elements shown in FIG. 1.

<4.2 Regulation of Source Output Voltage>

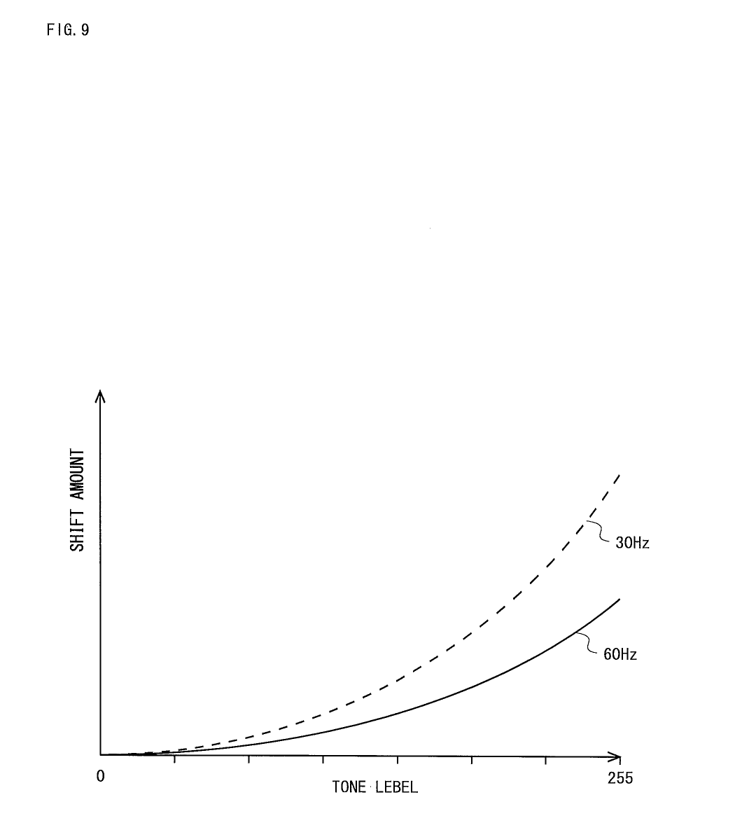

FIG. 9 is a diagram showing the relation between the shift amount from the flicker regulation voltage and the tone level with respect to each refresh frequency in a liquid crystal panel of the FFS system of the present embodiment. In FIG. 9, concerning the case of the refresh frequency of 30 Hz and the case of the refresh frequency of 60 Hz, the shift amount with respect to each tone level is described. In the case of either frequency, the shift amount is 0 when the tone level is the tone value 0, the shift amount monotonously increases with increase in tone level from the tone value 0 to the tone value 255, and a rate of increase (inclination of curve) therein rises with increase in tone level. Since the source output voltage is obtained by adding the shift amount to the flicker regulation voltage, the source output voltage also becomes the smallest at the tone value 0 and becomes the largest at the tone value 255.

Further, the shift amount corresponding to the same tone level is larger in the case of the refresh frequency of 30 Hz than in the case of 60 Hz, and a difference therebetween increases with increase in tone level. In FIG. 9, a solid line indicates the shift amount in the case of driving at the refresh frequency of 60 Hz, and a dotted line indicates the shift amount in the case of driving at the refresh frequency of 30 Hz.

It is to be noted that the description has been given in the case of the refresh frequency of 30 Hz and the case of the refresh frequency of 60 Hz in the present embodiment. However, the refresh frequency may be a higher frequency or a lower frequency than these. However, the lower the refresh frequency, the more the shift amount with respect to the same tone level needs to be increased. Further, the lower the refresh frequency, the larger the shift amount to be added to the flicker regulation voltage becomes, and hence the source output voltage obtained by adding the shift amount also becomes larger.

<4.3 Effect>

According to the present embodiment, since the source output voltage is obtained by adding the shift amount, obtained with respect to each refresh frequency, to the flicker regulation voltage, it is possible to apply the most suitable source output voltage to the liquid crystal panel with respect to each refresh frequency. Hence it is possible to suppress occurrence of the VCOM shift, which occurs when the liquid crystal panel is driven for a long period of time, regardless of the refresh frequency, so as to prevent burning caused by the VCOM shift.

### 5. Fifth Embodiment

A block diagram showing a configuration of a liquid crystal display device according to a fifth embodiment is the same as the block diagram shown in FIG. 1, and hence the block diagram and a description thereof will be omitted.

<5.1 Configuration of Display Control Circuit>

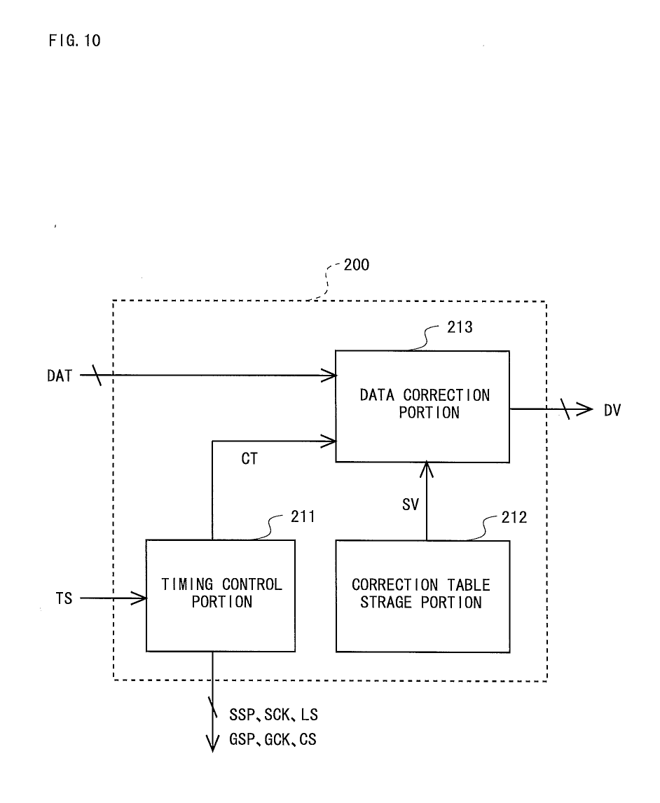

A configuration of the display control circuit 200 of the present embodiment is different from the configuration of the display control circuit 200 shown in FIG. 1, and hence the configuration of the display control circuit 200 of the present embodiment will be described. FIG. 10 is a block diagram showing the configuration of the display control circuit 200 in the present embodiment. As shown in FIG. 10, the display control circuit 200 includes a timing control portion 211 for performing timing control, a correction table storage portion 212 for storing correction data necessary for preventing flicker and burning, and a data correction portion 213 for correcting display tone data included in the image data DAT given from the outside. The data correction portion 213 corrects the display tone data based on correction data stored in the correction table storage portion 212.

The timing control portion 211 receives the timing control signal TS given from the outside, and outputs a control signal CT for controlling operation of the data correction portion 213, and the source start pulse signal SSP, the source clock signal SCK, the latch strobe signal LS, the gate start pulse signal GSP, the gate clock signal GCK and the common voltage control signal CS for controlling timing at which an image is displayed on the display portion 100.

The correction table storage portion 212 stores, as a look up table (hereinafter referred to as “LUT”), correction data for converting display tone data included in the image data DAT given to the data correction portion 213 to display tone data capable of preventing flicker and burning.

<5.2 Regulation of Source Output Voltage>

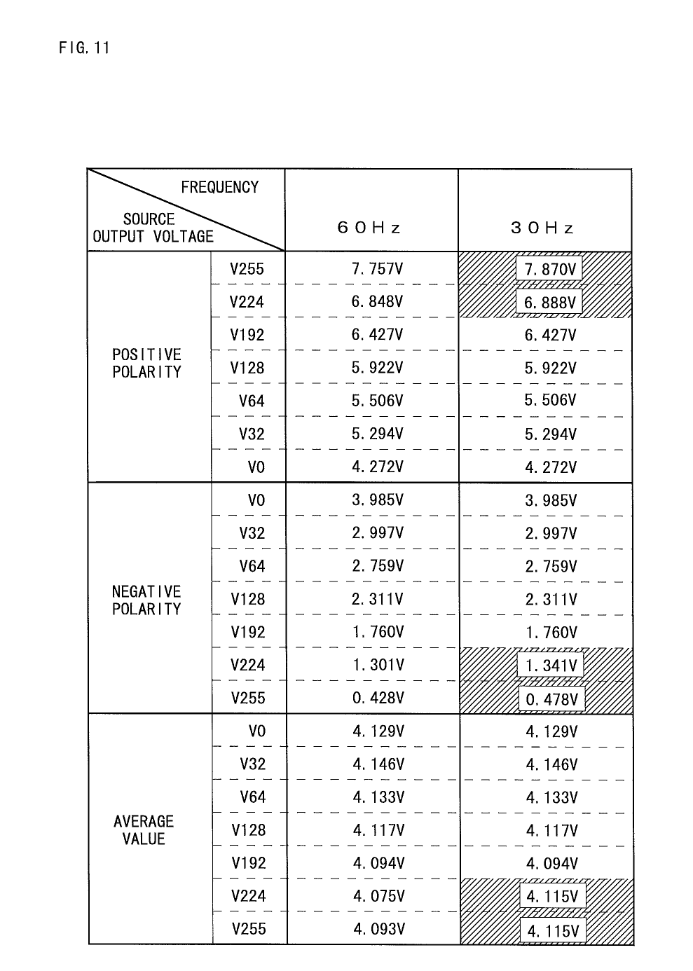

FIG. 11 is a diagram showing, as an LUT, the relation between a source output voltage and a tone level in the case of the refresh frequency of 30 Hz and the case of the refresh frequency of 60 Hz. As shown in FIG. 11, as correction data for converting display tone data of the image data DAT to the most suitable display tone data for preventing flicker and burning, source output voltages at the tone value 0, the tone value 32, the tone value 64, the tone value 128, the tone value 192, the tone value 224 and the tone value 255 are stored in the LUT of the correction table storage portion 212 with respect to each refresh frequency and with respect to each polarity of a voltage that is to be applied to the pixel electrode 121.

When seven kinds of source output voltages shown in FIG. 11 are inputted as the tone reference voltages Vγ1 to Vγ7 to the tone voltage generation circuit 320, the tone voltage generation circuit 320 outputs the group of tone voltages V0 to V255, and the group of these tone voltages V0 to V255 is selected by the selection circuit 313 and applied as the source output voltage to the source bus lines SL1 to SLm. Thereby, the source output voltage is written into each pixel formation portion 120.

Further, as shown in FIG. 11, average values of the source output voltages corresponding to the tone levels of the tone value 0, the tone value 32, the tone value 64, the tone value 128 and the tone value 192 are the same values regardless of the refresh frequency. However, average values of the source output voltages in the case of 30 Hz is +40 mV larger at the tone value 224 and +50 mV larger at the tone value 255 than average values of the source output voltages in the case of 60 Hz. Hence the tone voltage generation circuit 320 outputs a larger tone voltage as a source output voltage corresponding to each of tone levels from the tone value 193 to the tone value 223 and each of tone levels from the tone value 225 tone to a tone value 254 in the case of the refresh frequency of 30 Hz than in the case of the refresh frequency of 60 Hz.

Next, the case of switching the refresh frequency will be described. In the case of switching the refresh frequency from 60 Hz to 30 Hz, when the source output voltage has a positive polarity, 6.888 V, obtained by adding 40 mV to 6.648 V corresponding to the tone value 224 at the time of 60 Hz, is set as the source output voltage at the time of 30 Hz, and 7.807 V, obtained by adding 50 mV to 7.757 V corresponding to the tone value 255 at the time of 60 Hz, is set as the source output voltage at the time of 30 Hz. Similarly, when the source output voltage has a negative polarity, 1.341 V, obtained by adding 40 mV to 1.301 V corresponding to the tone value 224 at the time of 60 Hz, is set as the source output voltage at the time of 30 Hz, and 0.478 V obtained by adding 50 mV to 0.428 V corresponding to the tone value 255 at the time of 60 Hz, is set as the source output voltage at the time of 30 Hz.

Accordingly, the source output voltage corresponding to each of tone levels from the tone value 193 to the tone value 223 and each of tone levels from the tone value 225 to the tone value 254, outputted from the tone voltage generation circuit 320, is also outputted as a tone voltage obtained by shifting the source output voltage at the time of 60 Hz to the plus side.

Although the case of switching the refresh frequency from 60 Hz to 30 Hz has been described, the case of switching the refresh frequency from 30 Hz to 60 Hz is similar to the above case, and hence its description will be omitted.

<5.3 Effect>

According to the present embodiment, the source output voltage corresponding to the highest tone level and in the vicinity thereof is stored in the correction table storage portion 212 as the display tone data of the image data DAT in the form of the LUT. The display control circuit 200 reads the source output voltage stored in the LUT and corrects the display tone data of the image data DAT. Thereby, occurrence of the VCOM shift which occurs when the liquid crystal panel is driven for a long period of time is suppressed, and hence burning caused by the VCOM shift is prevented.

Further, when the refresh frequency is switched when an image is displayed on the display portion 100, a source output voltage corresponding to the refresh frequency after switched is read from the LUT of the correction table storage portion 212, thereby regulating the source output voltage at the highest tone level and in the vicinity thereof. Thus, even when the refresh frequency is switched, the most suitable source output voltage corresponding to the refresh frequency after switched is applied to the liquid crystal panel, whereby occurrence of the VCOM shift which occurs when the liquid crystal panel is driven for a long period of time is suppressed, and burning caused by the VCOM shift is prevented.

The LUT can store the correction data in a simple form as table information associated with the display tone data. Further, the LUT can easily add or change the correction data in the case of adding new correction data or changing the stored correction data.

<5.4 Modified Example>

In the above embodiment, the correction data concerning the tone levels of seven tones from the tone value 0 to the tone value 255 have been stored in the LUT of the correction table storage portion 212. However, correction data corresponding to every tone level from the tone value 0 to the tone value 255 may be stored into the LUT. This can further facilitate changing correction data and further simplifies the configuration of the liquid crystal display device.

In the above embodiment, the correction data to be stored into the LUT has been assumed to be the source output voltage. However, the correspondence relation between display tone data before corrected and display tone data after corrected, a correction coefficient, and the like may be stored into the LUT as correction data.

In the above embodiment, refresh frequency information is also given from the outside along with the image data DAT. However, an image determination portion (not shown) may be provided in the display control circuit 200 and an image with a different refresh frequency may be switched. In this case, the image determination portion functions as a frequency switching circuit, and switches the LUT that stores correction data corresponding to the refresh frequency.

<6. Others>

In each of the above embodiments and the modified examples thereof, the descriptions have been given of the source output voltage of the liquid crystal panel of the lateral electric field system, and the shift amount thereof. This is because the present invention exerts a large effect on the liquid crystal panel of the lateral electric field system whose electrode structure is asymmetrical. However, also in the liquid crystal panel of the longitudinal electric field system, it is possible to prevent burning caused by the VCOM shift when the liquid crystal panel is driven for a long period of time.

Further, in each of the above embodiments, the liquid crystal display device of the frame-reversal driving system has been described. However, the system is not restricted to the frame-reversal driving system, and it may be any of a dot-reversal driving system, a line-reversal driving system and a column-reversal driving system.

### INDUSTRIAL APPLICABILITY

The present invention is applicable to a display device capable of preventing burning which occurs when a liquid crystal panel is driven for a long period of time.

### DESCRIPTION OF REFERENCE CHARACTERS

100: display portion

110: common electrode

120: pixel formation portion

121: pixel electrode

125: thin film transistor

200: display control circuit

212: correction table storage portion

213: data correction portion

300: source driver (date signal line drive circuit)

320: tone voltage generation circuit

321: voltage division circuit

400: gate driver (scanning signal line drive circuit)

GL1 to GLn: gate bus line (scanning signal line)

SL1 to SLm: source bus line (data signal line)

Ccl: liquid crystal capacitance (pixel capacitance)

DAT: image data (image signal)

1. An active matrix-type display device which is subjected to AC drive, the device comprising:
a plurality of scanning signal lines and a plurality of data signal lines that intersect with the plurality of scanning signal lines;
a plurality of pixel formation portions arranged in a matrix form, respectively corresponding to intersections of the plurality of scanning signal lines and the plurality of data signal lines;
a scanning signal line drive circuit configured sequentially to activate the plurality of scanning signal lines;
a date signal line drive circuit configured to apply a flicker regulation voltage, which has been regulated so as to display an image with the minimum flicker, to the plurality of data signal lines in order to write the flicker regulation voltage into the pixel formation portion connected to a selected scanning signal line; and
a display control circuit configured to give a predetermined control signal to the scanning signal line drive circuit and the date signal line drive circuit, to perform control,
wherein one of the date signal line drive circuit and the display control circuit adds a plus shift amount to the flicker regulation voltage with a tone level in a predetermined range which at least includes the highest tone level.

2. The display device according to claim 1, wherein the shift amount monotonously increases with increase in a tone level.

3. The display device according to claim 2, wherein a rate of increase in shift amount with respect to the tone level rises with increase in the tone level.

4. The display device according to claim 1, wherein the shift amount is a plus value at every tone level.

5. The display device according to claim 1, wherein the shift amount is a plus value at a higher tone level than the predetermined tone level.

6. The display device according to claim 1, wherein
the shift amount varies in accordance with a refresh frequency of an image signal given from the outside, and
the lower the refresh frequency, the larger the value of the shift amount.

7. The display device according to claim 1, wherein the display control circuit stores correction data configured to correct a voltage to be written into the pixel formation portion as table information associated with a display tone corresponding to an image signal given from the outside.

8. The display device according to claim 1,
wherein the pixel formation portion includes:
a thin film transistor which comes into a conducting state or a blocking state in accordance with a scanning signal that is applied to the scanning signal line;
a pixel electrode which is connected to the data signal line via the thin film transistor;
a pixel capacitance which is formed of the pixel electrode and a common electrode provided so as to face the pixel electrode; and
a liquid crystal layer which displays a pixel with atone in accordance with a voltage that is held in the pixel capacitance,
wherein a semiconductor layer of the thin film transistor is made up of indium oxide, gallium and zinc.

9. The display device according to claim 8, wherein the pixel formation portion includes the pixel electrode and the common electrode so as to apply an electric field in a lateral electric field system to the liquid crystal layer.

10. The display device according to claim 8, wherein the pixel formation portion includes the pixel electrode and the common electrode so as to apply an electric field in a longitudinal electric field system to the liquid crystal layer.

11. Electronic equipment, comprising the display device according to claim 1.

12. A drive method of a liquid crystal display device which includes
a plurality of scanning signal lines and a plurality of data signal lines that intersect with the plurality of scanning signal lines, and
a plurality of pixel formation portions arranged in a matrix form, respectively corresponding to intersections of the plurality of scanning signal lines and the plurality of data signal lines,
the device being an active matrix-type display device which is subjected to an AC drive,
the method comprising the steps of:
sequentially selecting the plurality of scanning signal lines;
applying a flicker regulation voltage, which has been regulated so as to form an image with the minimum flicker, to the plurality of data signal lines in order to write the flicker regulation voltage into the pixel formation portion connected to a selected scanning signal line; and
giving a predetermined control signal to perform control in the step of selecting the scanning signal line and the step of applying the flicker regulation voltage to the plurality of data signal lines,
wherein in the step of applying the flicker regulation voltage to the plurality of data signal lines, a plus shift amount is added to the flicker regulation voltage with a tone level in a predetermined range which at least includes the highest tone level.
